(19) United States
(12) Patent Application Publication
(10) Pub. No.: US 2009/0235297 A1
(43) Pub. Date: Sep. 17, 2009

(54) SYSTEMS AND METHODS FOR CAPTURING PROGRAM ATTRIBUTES

(75) Inventor: Andrew Ferrone, Santa Monica, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties, Inc., Los Angeles, CA (US)

(21) Appl. No.: 12/055,253

(22) Filed: Mar. 25, 2008

Related U.S. Application Data
(60) Provisional application No. 61/036,136, filed on Mar. 13, 2008.

(51) Int. Cl. H04N 7/173

(52) U.S. Cl. 725/24

(57) ABSTRACT

A method for assigning attributes to media content. A media content is first displayed on a television, computer, or other display. A communication created by a user while viewing the media content is then received. The communication is then analyzed, and at least a portion of the communication is linked to a portion of the media content. The communication is also analyzed to identify relevant keywords which are then saved as attributes of the media content. The assigned word or phrase can be used to recommend the media content to other viewers or to find the media content in response to a search function. A method for synchronizing communications with time-shifted media content is also disclosed. A media content such as a television program is displayed during a time period other than its original broadcast time. Communications created by users while watching the media content are then received. The received communications are time-stamped so they can be synchronized with the run-time of the media content. The communications may be analyzed to select and display targeted advertising.

This application claims the benefit of U.S. Provisional Application No. 61/036,136, filed Mar. 13, 2008, the disclosure of which is hereby incorporated by reference herein in its entirety.

### BACKGROUND OF THE INVENTION

Embodiments of the invention relate generally to media systems and methods, and more particularly, to media systems and methods that capture program attributes and synchronize media content with related communications.

The amount and variety of media content available to viewers has increased dramatically in recent years. In addition to hundreds of conventional broadcast television channels, consumers may now access a nearly limitless amount of video and other content via computers, mobile phones, and other wired and wireless broadband devices. Unfortunately, the proliferation of media content sources and titles overwhelms many consumers. A participant in a TV Guide focus group recently expressed his frustration this way: “Whenever there is [an] increase in channels by my satellite company, there seems to be less to watch.”

An interactive media guidance application allows a user to more easily navigate through the wide array of media content accessible by a typical user's equipment. An interactive media guidance application may also perform one of several media guidance application functions on content accessible by a user's equipment. These media guidance application functions may include searching for desired content, scheduling a selected content to be recorded, recording the selected content to a local storage device or remote media server, adding the selected content to a favorite programs list, setting a reminder for the selected content, ordering the selected content via an on-demand (e.g., video on-demand or VOD) or pay-per-view (PPV) service, or any other suitable function.

To simplify and facilitate the discovery of media content, many interactive media guidance applications provide recommendations based on users' viewing habits, editorial programming picks, or other methods. Although such recommendations often help users find media content that more closely fits their preferences, the creation of recommendations requires time-consuming and costly research, monitoring, and data-mining of viewer profiles and viewing habits. Recommendations must also be constantly updated as new media content is released and as viewer preferences of existing programming change (e.g. when an existing program begins to draw a different demographic group).

Many interactive media guidance applications also provide search functions that locate media content in response to user-entered keywords or phrases. Unfortunately, many of these search functions are too basic because they only compare entered keywords to media content titles. Some search functions are more powerful, but as with recommendations, they require costly and time-consuming efforts to link or otherwise associate media content with various keywords.

People often multi-task while watching television programs and other media content. For example, with the increased popularity of the Internet, web logs (blogs), instant messaging, and other communications, it is now common for people to watch TV while writing or reading messages and/or researching something about what they are watching. Because of this, many web logs are now organized around the broadcast times of popular TV shows and movies.

Although TV-related web logs are entertaining and informative for viewers who watch programs at their original broadcast times and therefore read the blogs as the programs progress, they are less desirable for viewers who watch re-runs and/or who record media content for later viewing because the previously-entered web log entries are not synchronized with the program. For example, a viewer may have little interest in a previously entered web log entry discussing a scene at the end of a program while the user is watching the beginning of the program. Previously-entered blog entries also often give away plot twists or other details of programs before the viewers get to see them.

Similarly, previously-entered web log entries may have no interest to later viewers because the same program played in different dayparts may attract totally different demographics. For example, a program broadcast during primetime hours may be watched by middle-aged and older adults, but late-night re-runs or recordings of the exact same program may be watched by college-aged people and teenagers. Blog entries made by the older adults may have no interest to the college-aged viewers, and vice versa.

### SUMMARY OF THE INVENTION

Embodiments of the present invention solve the above-described problems and provide enhanced systems and methods for media content.

One exemplary embodiment is a method for assigning attributes to media content. A media content such as a television program is first displayed on a television, computer, or other display. A communication created by a user while viewing the media content is then received. The communication may be, for example, a web log entry discussing some aspect of the media content and may be received at an Internet-accessible live discussion group associated with the media content.

At least a portion of the communication is then linked or otherwise assigned to a portion of the media content based on when the communication was received. For example, if a communication is received at 8:12 P.M. for a media content broadcast at 8:00 P.M, a portion of the media content may be linked or otherwise assigned to the first fifteen minutes of the media content, the 11^{th} or 12^{th} minute of the run-time of the media content, or even a particular scene, frame, or group of frames of the media content.

The communication may also be analyzed to identify relevant keywords which are then saved as attributes of the media content. For example, if the communication and other communications from other viewers frequently mention a specific actor or actress, scene, or other attribute of the media content, the repeated word (e.g. Patrick Dempsey) or phrase (“awesome house”) may be assigned as an attribute to a portion of the media content.

The assigned attribute can then be subsequently used to recommend the media content to other viewers who may have an interest in the actor, actress, scene, or other attribute. The assigned attribute may also be used to direct viewers to the particular portion of the media content which elicited the corresponding communication. Similarly, the assigned attribute can also be used to find the media content, or a particular portion of the media content, in response to a search function.

Because the present invention derives attributes from actual viewer communications, the attributes have a strong, real-world correlation with the media content. Moreover, the attributes can be determined without time-consuming and costly research of viewing habits and similar data. And because the present invention links or otherwise assigns attributes to particular portions of media content, particular scenes or even frames of a media content can be easily located with the attributes.

Another exemplary embodiment of the invention is a method for synchronizing communications with time-shifted media content. A media content such as a television program is displayed during a time period other than its original broadcast time. For example, the media content may be a re-run or a previously recorded program. A play-back time for the recorded media content or a watch group for the re-run may be coordinated (for example, through a sign-up system) so that multiple people can watch the program at the same time. This permits demographically-aligned groups of people to watch the media content together and share communications. For example, a group of college-aged people may sign up to watch a re-run or previously recorded program at midnight.

Communications created by users while watching the re-run or recorded media content are then received. The communications may be received at a web log specifically created for the particular display time of the media content. The received communications may be time-stamped and synchronized with the run-time of the media content. For example, a communication received at 1:02 A.M. Central Standard Time (CST) may be linked or associated with the ending scenes of a program re-broadcast from 11:00 P.M. to 1:00 A.M. CST. The communication may also be linked with a particular scene or even a frame or group of frames of the program.

A media content and communications entered by users while watching the media content may be recorded together so that later viewers may simultaneously watch the media content and read the previously entered communications. During playback of the media content, the chat communications are preferably synchronized with the run-time of the media content. For example, a communication received during the 12^{th} minute of the media content is also displayed at the 12^{th} minute of a subsequent playback of the media content. Similarly, a communication received during a car chase scene of a media content may be displayed during the same car chase scene when the media content is displayed again. This simulates the “live” experience of a chat session for viewers who were not able to watch the media content when the chat session was first created.

The communications entered by viewers may also be analyzed to select and display targeted advertising. For example, if several communications mention the phrase “cool car,” an advertisement for a brand of car shown in the media content may be displayed. The targeted advertising may be displayed alongside the blogs or other communications or may be shown in the next interstitial of the media content. At least some of the communications may also be displayed alongside the media content.

These and other embodiments of the invention may be at least partially implemented with an interactive media guidance application which uses a user's equipment to display media content listings. The media content listings may be television program listings and may list the titles of television programs, their broadcast times, and other relevant information. A user may select to view the media content described by a listing by highlighting the media content listing and pressing an “Enter” or “Select” button on a remote control device or other input device. The media guidance application then tunes a receiver to the appropriate channel.

These and other important aspects of the present invention are described more fully in the detailed description below.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative display screen that may be used to provide media guidance application listings in accordance with an embodiment of the invention;

FIG. 2 shows another illustrative display screen that may be used to provide media guidance application listings in accordance with an embodiment of the invention;

FIG. 3 shows an illustrative user equipment device in accordance with an embodiment of the invention;

FIG. 4 is a diagram of an illustrative interactive media system in accordance with an embodiment of the invention;

FIG. 5 is an illustrative display screen showing recording options on an overlay in accordance with an embodiment of the invention;

FIG. 6 is an illustrative display screen showing media content listings for media content that has been recorded or is scheduled for recording in accordance with an embodiment of the invention; and

FIG. 7 is an illustrative display screen showing playback options in accordance with an embodiment of the invention;

FIG. 8 is an illustrative display screen showing the synchronized display of media content and communications in accordance with an embodiment of the invention;

FIG. 9 is another illustrative display screen showing the synchronized display of media content and communications in accordance with an embodiment of the invention;

FIG. 10 is a database or data table showing portions of a media content associated with keywords in accordance with an embodiment of the invention;

FIG. 11 shows an illustrative process for assigning attributes to a media content in accordance with an embodiment of the invention;

FIG. 12 shows an illustrative process for assigning attributes to a media content in accordance with another embodiment of the invention;

FIG. 13 shows an illustrative process for synchronizing media content and related communications in accordance with another embodiment of the invention.

### DETAILED DESCRIPTION OF THE PREFERRED EMBODIMENTS

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

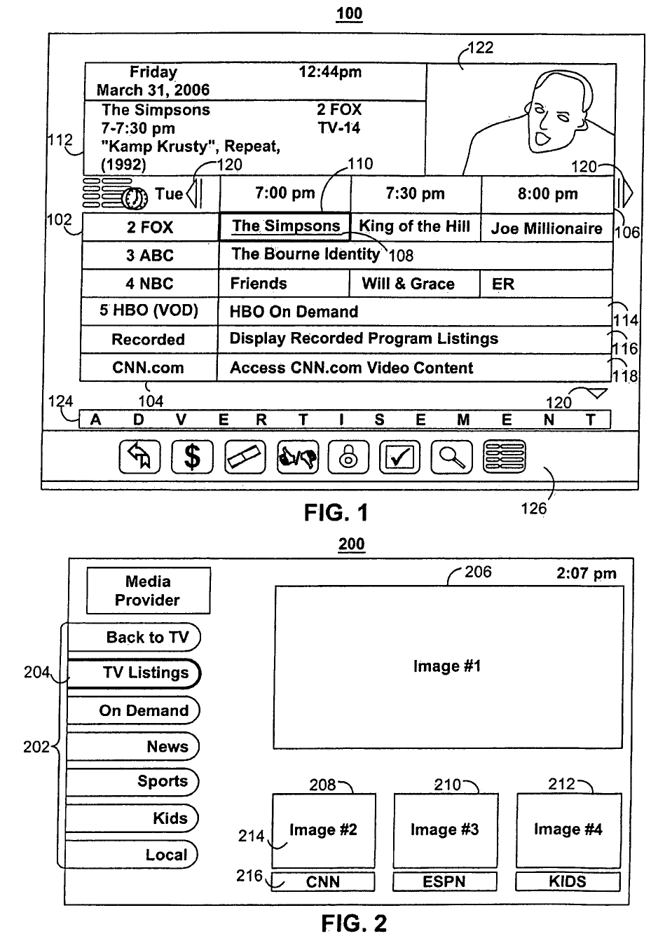

One of the functions of the media guidance application is to provide media listings and media information to users. FIGS. 1-2 show illustrative display screens that may be used to provide media guidance, and in particular media listings. The display screens shown in FIGS. 1-2 and FIGS. 5-8 may be implemented on any suitable device or platform. The displays of FIGS. 1, 2, and 5-9 may be full screen displays or may be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND, THE SOPRANOS, and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

Users may access media content and the media guidance application (and its display screens described above and below) from one or more of their user equipment devices. The user equipment devices may be personal computers, televisions, or any other devices. For example, one user equipment device may be a personal computer provided with a tuner card that allows TV signals to be displayed on the computer monitor. The user equipment device may also be television equipment with a set-top box or receiver that permits access to the Internet via a cable connection phone line, or other communication line.

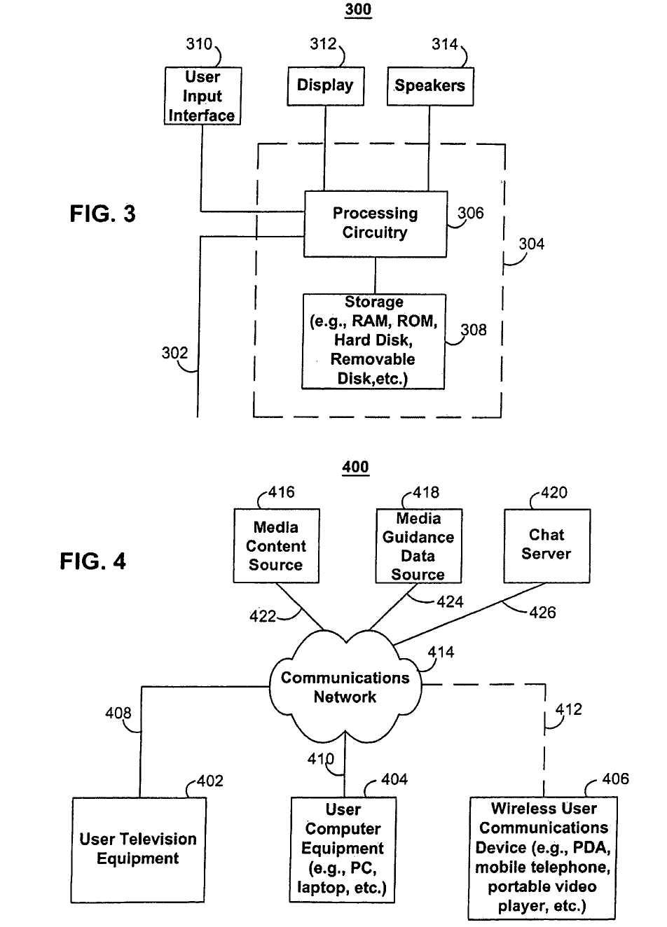

FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a trademark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a trademark owned by Bluetooth SIG, INC. The user equipment devices may also communicate with each other directly through an indirect path via communications network 414.

System 400 includes media content source 416, media guidance data source 418, and chat server 420 coupled to communications network 414 via communication paths 422, 242, and 426, respectively. Paths 420 and 426 may include any of the communication paths described above in connection with paths 408, 410, and 412. Communications with the media content source 416, media guidance data source 418, and chat server 420 may be exchanged over one or more communications paths, but are shown as a single path in FIG. 4 to avoid overcomplicating the drawing. In addition, there may be more than one of each of media content source 416, media guidance data source 418, and chat server 420, but only one of each is shown in FIG. 4 to avoid overcomplicating the drawing. (The different types of each of these sources are discussed below.) If desired, media content source 416, media guidance data source 418, and chat server 420 may be integrated as one or two source devices. Although communications between sources 416, 418, and 420 with user equipment devices 402, 404, and 406 are shown as through communications network 414, in some embodiments, sources 416, 418, and 420 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel).

Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Chat server 420 may be integrated in the media content source 416 or media guidance data source 418 as described above or may be a stand-alone server. In some embodiments, the chat server hosts one or more Internet-accessible discussion groups, web logs, or similar chat groups as discussed in more detail below.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

In one exemplary embodiment, the above-described media guidance application, user equipment device 300 and system 400 implement a system and method for capturing attributes of a media content. The attributes may then be used to recommend the media content to viewers, locate the media content in response to a search query, display targeted advertising to viewers, and other functions as described in more detail below.

The media guidance application first displays at least one media content listing. The media content listing may be a television program listing 108 such as the one shown in FIG. 1 and may list the title of the television program, its broadcast time, and other relevant information. A user may select to view a media content by highlighting a corresponding listing and pressing an “Enter” or “Select” button on a remote control device or other input device. The media guidance application then tunes a receiver or other component on the user equipment device 300 to the appropriate channel to display the media content on a television, computer, or other display.

The user and other viewers may then create communications (also referred to herein as “messages”) while viewing the media content. The communications are then synchronized with particular portions of the media content based on when the communications were received as described in more detail below.

The communications may consist of text, audio, video, and/or HTML. Text-only communications require less bandwidth and therefore may be used in some embodiments. The communications may be, for example, web log entries discussing some aspect of the media content and may be received at an Internet-accessible live discussion group associated with the media content.

In some embodiments, the communications are synchronized with particular run-time portions of the media content. To more easily do so, the communications are preferably entered with a device coupled to or in direct communication with a display or monitor on which the media content is displayed. For example, in some embodiments, the communications are entered on set-top boxes coupled to televisions on which the media content is displayed. In other embodiments, the communications are entered with computers coupled to monitors on which the media content is displayed. However, it is not required that the media content and communications be displayed and entered on connected devices. For example, the communications can be entered via computers when the media content is displayed on televisions. Likewise, the communications can be entered via set-top boxes when the media content is displayed on computer monitors.

The communications may be received by the chat server 420, media guidance data source 418 or other computer device. In one embodiment, the communications are entered with a chat application implemented partially on a television set-top box or computer. The chat application may be deployed by a website (e.g. www.Fanspace.TVGuide.com) hosted by the chat server or other computer. A chat room may terminate at the end of a media content or may continue beyond the end of the media content until all of the users have exited the chat room.

Various mechanisms may be used for launching the chat application. For example, the chat application may be associated with a hot link that connects a user set-top box or computer with a web site address, e-mail address, chat group, or other destination that has been preselected based on the current content of the media guidance application or status of the set-top box. For example, if a user is watching a program, viewing a program listing, viewing the description of a program, or taking another action within the media guidance application related to a given program, an invitation to launch a chat application related to the program may be displayed. If the user launches the chat application, the user's set-top box or computer is connected to a chat group specifically assigned to the program.

Hot links may be activated by dedicated buttons, a launch button, menu options, or any other suitable technique. For example, a remote control may be provided with a dedicated chat button. When the user presses the chat button, the media guidance application launches the chat application and directs the chat application to set up a chat group with other users or join the user to an existing chat group.

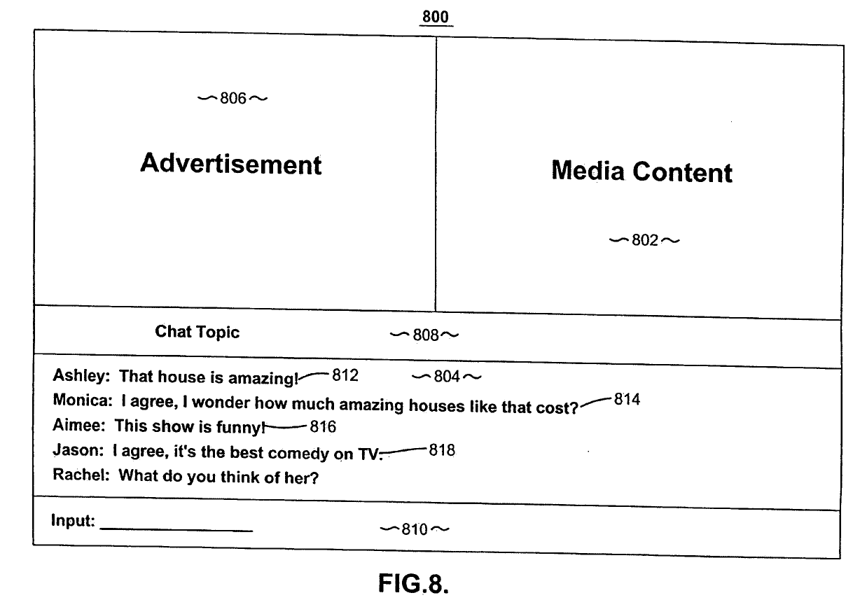

In some embodiments, communications received from viewers are displayed alongside the media content so that users can simultaneously watch the media content and read posted communications. FIG. 8 shows an exemplary display screen 800 that simultaneously shows media content and related communications. A media content such as a television program may be displayed in region 802 of the display screen 800. Communications or a chat room may be displayed simultaneously in region 804 of the display screen 800. Advertisements may also be simultaneously displayed in region 806 of the display screen 800. Region 808 may list a chat topic and/or provide other descriptive information and region 810 may provide an area to input new communications.

The divided nature of screen 800 allows users to simultaneously watch a television program or other media content and send communications to other users who are viewing the same program at the same time. In this way, the communications are directly linked to the media content.

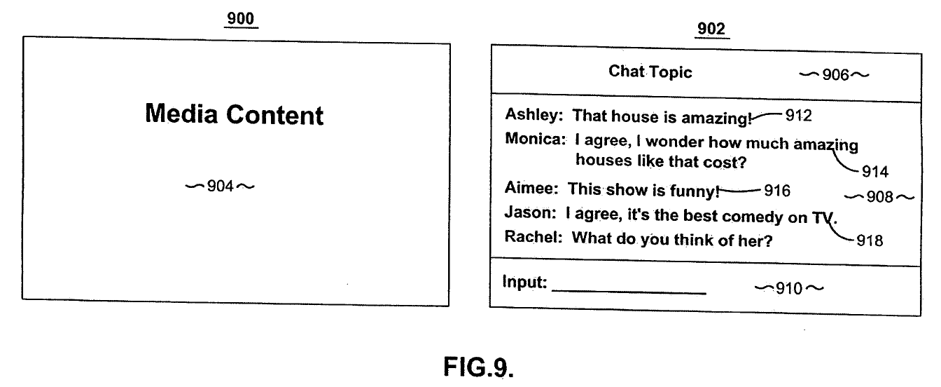

The display screen 800 shown in FIG. 8 is merely illustrative and may be replaced with any suitable display screen arrangement. For example, the chat room region 804 may be displayed as an opaque or translucent overlay on the media content region 802. Moreover, the media content and communications do not necessarily have to be displayed on the same display screen. FIG. 9 illustrates an exemplary display arrangement in which the media content is displayed on a first display 900 and communications are displayed on a second display 902. The first display 900 may be, for example, a television monitor, and may include a region 904 for displaying media content. The second display 902 may be, for example, a laptop or desktop computer display or even a personal digital assistant (PDA) display. As with display 800, display 902 may include a region 906 for listing a chat topic and/or other descriptive information, a region 908 for communications 912-918, and a region 910 for inputting a new communication.

After the communications are received, they are synchronized with particular portions of the media content. In some embodiments, the chat server or other computer does this by time-stamping the communications as they are received. The time stamps are then used to associate the communications with particular run-time portions of the media content. For example, if the communications 812 and 814 shown in FIG. 8 are time-stamped 8:12 P.M. and 8:13 P.M., respectively, they may be associated with the first fifteen minutes of an 8:00 P.M. program. The synchronization may also be more precise. For example, each communication may be associated with a particular 1-minute or 2-minute interval of the media content or even a particular frame or group of frames of the media content. The communications may also be associated with a particular scene of a media content (e.g. an airport scene, a car chase scene, etc.).

Because communications typically take a few seconds to create and send, a “lag-time” of 15 seconds, 1 minute, or any other time interval may be considered to more accurately synchronize each communication with the media content run-time. For example, a communication received 16 minutes after the beginning of a program may be associated with the 15^{th} minute of the program.

The communications are then analyzed to determine attributes of the media content. The attributes are then assigned to a portion of the media content based on the receipt time of the communications. For example, if several received communications frequently mention a specific actor or actress, scene, or other attribute of a media content, the repeated word or phrase may be assigned to a portion of the media content corresponding to the receipt time of the communications.

Analysis of the communications is preferably done by the chat server or other computing device and may simply involve a comparison of the communications to discover repeated words or phrases. For example, when the communications 812 and 814 in FIG. 8 are compared, the repeated words “house” and “amazing” may be discovered. These repeated words may then be assigned as attributes of the media content. Similarly, the communications 816 and 818 may be compared to discover the related words “funny” and “comedy,” which are then assigned as attributes.

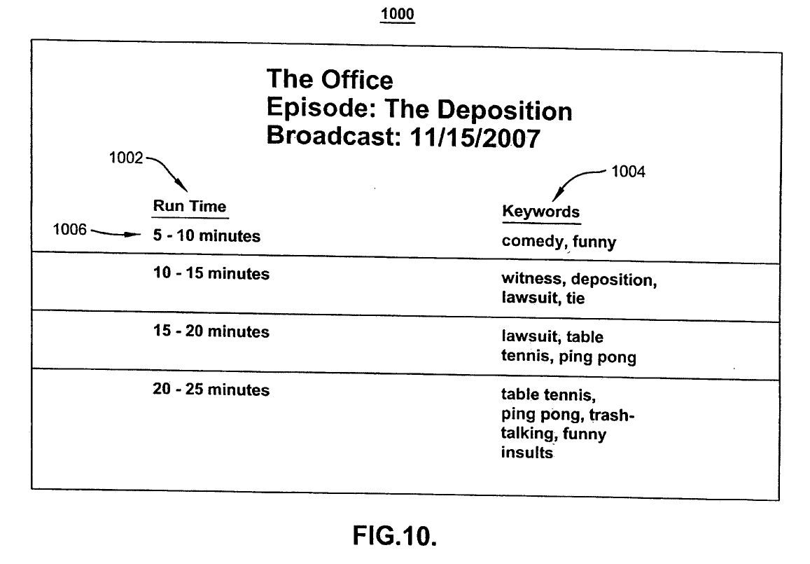

After the attributes are identified, the chat server or other computer may assign them to particular portions of the displayed media content based on the run-time of the media content and the receipt time of the communications. FIG. 10 shows how attributes may be assigned to an episode of the program “The Office.” The first column 1002 of FIG. 10 lists the run-time of the program divided into several time increments. The time increments may be specific (e.g. 15 seconds each) or more general (1^{st} quarter of program, 2^{nd} quarter of program, etc.) The second column 1004 lists the attributes or keywords obtained by analyzing the communications as discussed above. For example, line 1006 of FIG. 10 shows that communications with the words “comedy,” “funny,” or related words were contained in communications received approximately between the 5^{th} and 10^{th} minute of run-time of the program.

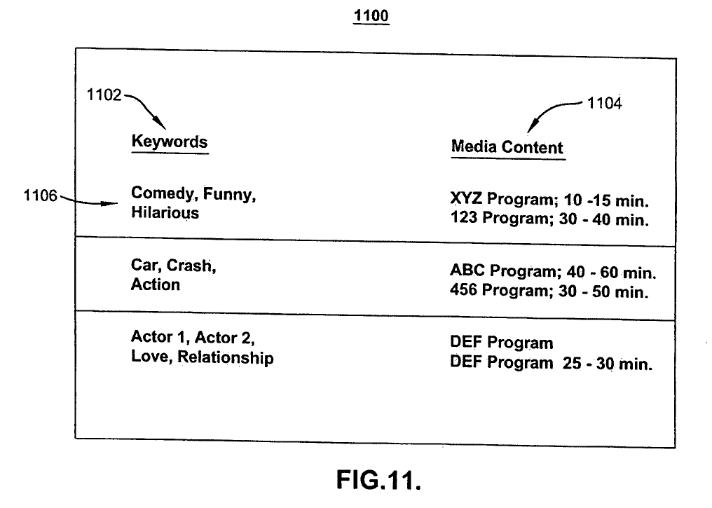

FIG. 11 illustrates another exemplary way to associate keywords or attributes with media content. FIG. 11 is similar to FIG. 10 except that is associates keywords with several programs rather than a single program as with FIG. 10. The first column 1102 of FIG. 11 lists keywords or attributes obtained from received communications as discussed above. The second column 1104 lists all (or at least several) media contents that have been associated with the corresponding keywords. For example, line 1106 of FIG. 11 shows that communications with the words “funny,” “hilarious,” “comedy,” or similar words were received near the 10-15 minute run time of the XYZ Program and near the 30-40 minute run time of the 123 Program.

The information shown in FIGS. 10 and 11 may be embodied in databases, tables, or any other data structures. Instead of, or in addition to, the databases of FIGS. 10 and 11, the keywords or attributes may be embedded in each frame of a media content so that the video is identifiable to the accuracy of a frame. Similarly if the media content is contained in a stream of packets, the keywords described above may be placed into informational packets that are located within the video stream. These informational packets contain headers identifying them as non-video packets. The information packets are not displayed, but are used to acquire the keywords for each whole, segment, or frame of the video.

The keywords or attributes assigned to a media content can be subsequently used to locate particular portions of the media content. For example, the assigned keywords can be used to find a media content or a particular portion thereof in response to a search function. A user may access a media guidance application search function and request a listing of comedies. The databases of FIG. 10 and/or FIG. 11 may be consulted to identify “The Office,” XYZ Program, and 123 Program as being associated with comedies. Media content listings for these programs may be displayed so the user may schedule a future recording of one of the programs. Because the communications, and the keywords or attributes gleaned from the communications, are time-synchronized with the running time of the media contents, the media guidance application function may also identify and recommend a particular portion of a media content (e.g. the first 10 minutes of “The Deposition” episode of “The Office”) in response to a search for comedies.

Similarly, during display of an NBA basketball game, the words “great shot,” “good play,” “Wow,” “Goooooal,” etc. may be entered in a chat log or other message center. At least some of these words may then be assigned to the game or particular portions of the game to highlight the best plays of the game. During subsequent playback of the game, the words can be used as “bookmarks” to skip to particular portions of the game. For example, a viewer could read ahead in a chat log for specific keywords or comments and click on a word or comment to jump the playback to the portion of the game that elicited the comment.

The communications entered by viewers may also be used to create a highlight reel showing the day's or week's best (or most talked about) video clips. For example, sports plays, news stories, program scenes, etc. that elicit the most communications during a time period (a day, week, etc.) may be aggregated into one or more highlight reels so viewers can quickly and easily watch the most hyped media content segments. This would enable volunteer “commentators” to identify and annotate the most popular media content.

The communications entered by viewers may also be analyzed to select and display targeted advertising. For example, if several communications mention the phrase “cool car,” an advertisement for a brand of car shown in the media content may be displayed. The targeted advertising may be displayed alongside the blogs or other communications or may be shown in the next interstitial of the media content.

The entered communications, and/or the keywords identified from the communications, may also be used to recommend or suggest particular media content or portions of media content to other viewers based on user profile information derived from user history information and user monitoring. For example, using a scoring system, media content featuring a common content criteria (e.g., a common character) may be suggested to a user if the user frequently watches episodes meeting the same content criteria.

Because embodiments of the invention assign attributes to media content derived from actual viewer communications, the attributes have a strong, real-world correlation with the media content. Advantageously, the attributes can be assigned without time-consuming and costly research of viewing habits and similar data. Moreover, because the present invention links or otherwise assigns attributes to particular portions of media content, particular scenes or even frames of media content can be easily located by searching for the attributes.

In another exemplary embodiment of the invention, the interactive media guidance application, user equipment device 300 and system 400 implement a system and method for synchronizing communications with time-shifted media content. The time-shifted media content may include re-runs of originally broadcast media content or playbacks of previously recorded media content. As discussed in more detail below, the method enables viewers to watch media content at times other than the original broadcast time and to communicate with other viewers watching the media content at the same time.

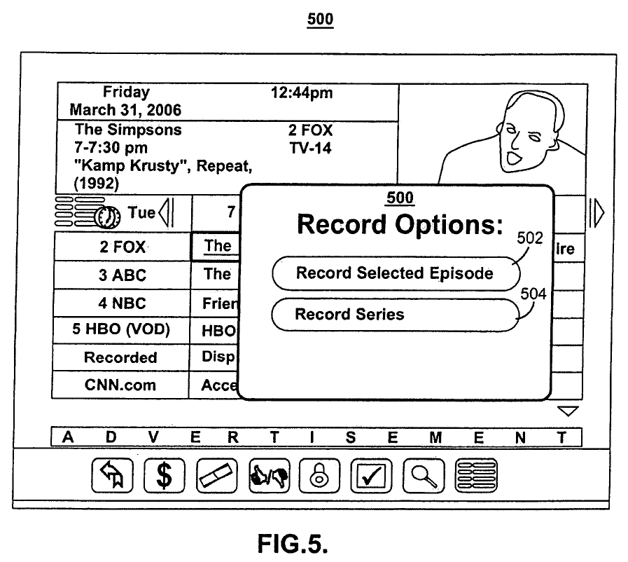

FIGS. 1, 5, and 6 demonstrate the steps to record a media content. A media guidance application may display several media content listings as shown in FIG. 1. A user may select to record the media content represented by a listing by moving the highlight region 110 over the media content listing 108 and pressing a “Record” button on the user input device 310. 101 The media guidance application may then present a record options overlay 500 such as the one illustrated in FIG. 5. The record options overlay 500 may display a Record Selected Episode selection 502 and a Record Series selection 504. If the user picks selections 500 or 504, the media guidance application schedules recording of a single episode or a series in a conventional manner.

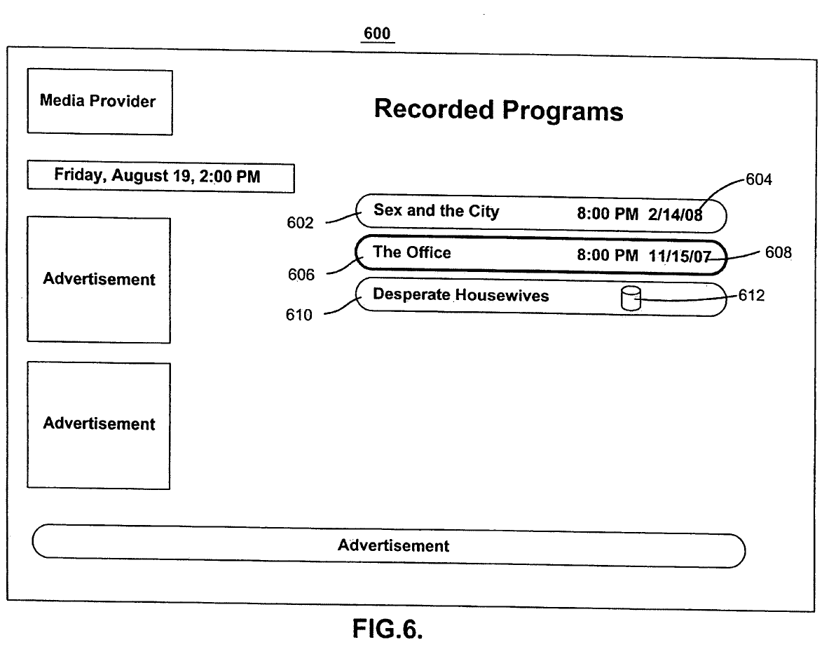

The user may later select to view the recorded media content by issuing a playback command. In response, the media guidance application may display a list of all recorded media content as illustrated in FIG. 6. Previously recorded media content 602 and 606 may be displayed, for example, at the beginning of the list and be accompanied by the time and date 604 and 608 of the recording. Media content 610 scheduled to be recorded in the future may be displayed next and may be accompanied by an icon 612 that indicates the media content is scheduled for recording. The user may request play-back of a recorded media content by highlighting a media content listing in the display 600 and then pressing “Enter” or another command on the user input device 310. In response to the user request, the media guidance application issues a play-back request to either the local storage device 308 or a remote storage device. The play-back request may include an identifier for the media content that the user wishes to play back and an identifier of the user. The play-back request may also include a pointer to a media directory on the local or remote storage device. The local or remote storage device then retrieves the requested media content and provides it to the user equipment device 300 as a suitable signal such as an NTSC video signal or an MPEG-2 video signal. The media content may be transferred to the user equipment device 300 in real time or in a compressed form such as a compressed video file.

Users may wish to watch a pre-recorded or re-run media content with other viewers and simultaneously communicate with the other viewers. For example, demographically-aligned groups, such as college-aged viewers, seniors, members of clubs, churches, or teams, may organize a display group around a particular re-broadcast time or playback time of a media content and communicate with on another while viewing the media content. Various methods may be employed to coordinate play-back times for pre-recorded media content and/or re-runs. For example, a play-back time for a recorded media content may be coordinated through a sign-up system. Users may also send chat requests to other users who are interested in a particular media content to coordinate playback times.

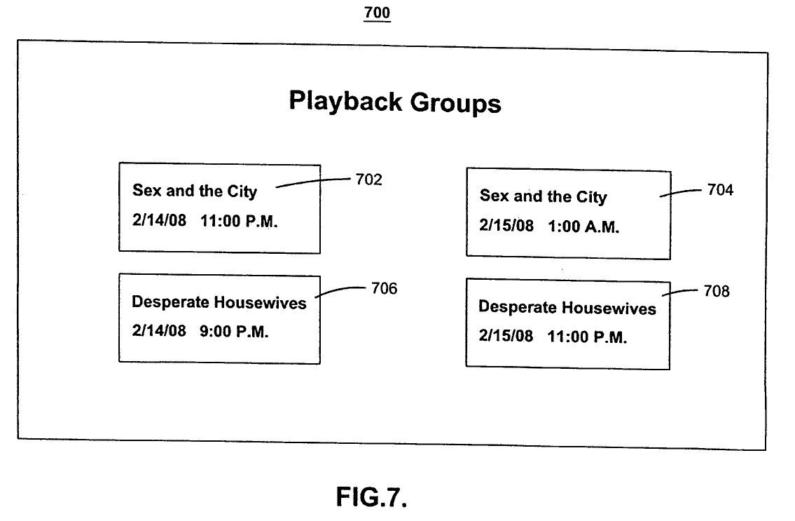

FIG. 7 illustrates an exemplary display screen 700 that may be used to coordinate play-back times. The display screen lists two suggested playback groups 702, 704 for the program “Sex and the City” and two suggested playback groups 706, 708 for the program “Desperate Housewives.” The playback groups may each be associated with a hot link or similar link that automatically tunes a user's equipment to the appropriate channel and/or DVR and connects the user's equipment to a corresponding chat group. For example, if a user wants to join the 11:00 P.M. Feb. 14, 2008 playback of “Sex and the City,” the user may click on the link 702. At the indicated day and time, the media guidance application may either tune the user's equipment 300 to the appropriate channel (if the program is being re-broadcast at that time) or may play back the program from a DVR or other storage device (if the program was previously recorded). At the same time, the media guidance application connects the user to the selected chat group so that the user may communicate with other viewers watching “Sex and the City” at the same time.

The user and other viewers may then create communications or messages while viewing the media content. The communications may consist of text, audio, video, and/or HTML. Text-only communications require less bandwidth and therefore may be used in some embodiments. The communications may be, for example, web log entries discussing some aspect of the media content and may be received at an Internet-accessible live discussion group associated with the media content. The communications are then synchronized with particular portions of the media content based on when the communications were received as described in more detail above.

As mentioned above, the communications are preferably entered with a device coupled to or in direct communication with a display or monitor on which the media content is displayed to more easily synchronize the communications with the run-time of the media content. For example, in some embodiments, the communications are entered on a set-top box coupled to a television on which the media content is displayed. In other embodiments, the communications are entered on a computer coupled to a monitor on which the media content is displayed.

In some embodiments, communications received from viewers are displayed alongside the media content so that users can simultaneously watch a media content and read posted communications. For example, the communications and media content may be simultaneously displayed on a display screen such as the one shown in FIG. 8 and described in detail above.

In other embodiments, communications are displayed on one display screen and the media content is displayed on another. For example, the communications and media content may be displayed on separate display screens 900 and 902 as shown in FIG. 9 and discussed above.

The received communications are then synchronized with the media content so that they may be associated with particular portions of the media content. In some embodiments, the chat server or other computer does this by time-stamping the communications as they are received. The time stamps are then used to associate the communications with particular run-time portions of the media content as described above.

In some embodiments, the communications are then analyzed to determine attributes of the media content. The attributes are then assigned to a portion of the media content based on when the communications were received. For example, if several received communications frequently mention a specific actor or actress, scene, or other attribute of a media content, the repeated word or phrase may be assigned to a portion of the media content corresponding to the receipt time of the communications. Analysis of the communication is preferably done by the chat server or other computing device and may simply involve a comparison of the communications to discover repeated words or phrases as discussed in more detail above.

After the attributes are identified, the chat server or other computer may assign them to particular portions of the displayed media content based on the run-time of the media content and the receipt time of the communications. FIG. 9 shows how attributes may be assigned to an episode of the program “The Office” and FIG. 10 shows how attributes may be assumed to several media content. FIG. 9 and 10 are discussed in more detail above.

The keywords or attributes assigned to a media content can be subsequently used to locate particular portions of the media content as described above.

Communications associated with a particular playback time or re-broadcast time of a media content may be stored along with the media content. For example, when a user requests to record a media content which has one or more associated chat sessions, the media guidance application may record the chat session along with the audio and video for the media content. The user may then later play back the media content and the chat session. During playback of the recorded media content and chat session, the chat communications are preferably synchronized with the run-time of the media content. For example, a communication received during the 12^{th} minute of a media content is also played back at the 12^{th} minute of a subsequent playback of the media content. Similarly, a communication received during a car chase scene of a media content may be displayed during the same car chase scene when the media content is displayed again. This simulates the “live” experience of a chat session for viewers who were not able to view the media content when the chat session was created.

Users may also watch a media content and simultaneously read communications from several previous chat sessions. For example, a first chat session may be created for the original broadcast time of a program and a second chat session may be created for a second showing (or any subsequent showing) of the media content. Both chat sessions may be recorded and then subsequently displayed during a third (or later) showing of the program. As with the previous embodiments, the chat communications from the first and second showings are synchronized with the run-time of the media content so that they are subsequently displayed at the appropriate time during the third (or subsequent) playback or re-broadcast of the media content. Again, this simulates the “live” experience of chat sessions for viewers who cannot participate in the initial creation of the chat sessions.

The media guidance application may be configured to play back the chat sessions in a format selected by the user. For example, a chat session may be played back as an overlay on top of the program, the program and the chat session may be displayed concurrently in reduced size windows on the TV screen as shown in FIG. 8, or the chat session and program may be displayed on separate screens as shown in FIG. 9. The media guidance application may also be instructed to record a chat session by itself, without recording the media content. That chat session may be stored (whether text, audio, video, or a combination), and viewed at a later time. Programs and chat sessions may also be recorded, for example, on a DVD device, a hard disk in the set-top box, or on a remote server.

Each of the display screens in FIGS. 1, 2, 5-9 may include a number of panel advertisements and banner advertisements. The size, shape, and location of the aforementioned advertisements may be altered without departing from the spirit of the invention, and more or less advertisements than those shown may be displayed, if desired.

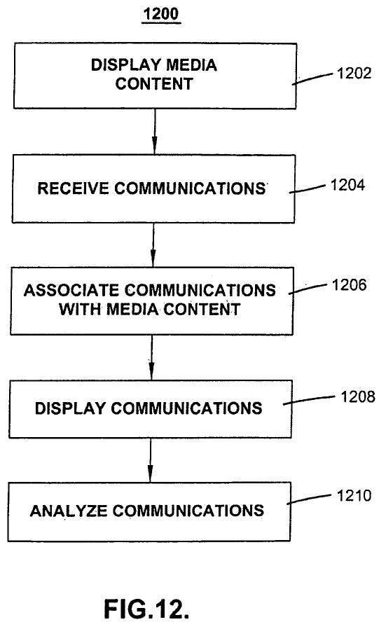

FIG. 12 shows an exemplary process 1200 for synchronizing communications with media content and capturing attributes of the media content. At step 1202, a media content such as a television program is displayed on a television, computer monitor, or other display. The media content may be displayed by a media guidance application such as an interactive television program guide.

At step 1204, communications are received from viewers of the media content. As explained in more detail above, the communications may be web log entries or other chat-type messages. In some embodiments, the communications are entered by the viewers on set-top boxes coupled to the users' televisions.

At step 1206, the communications are associated with particular portions of the media content based on when the communications were received. For example, the communications may be time-stamped upon receipt and then associated with particular run-time portions of the media content based on the time stamps.

At step 1208, at least some of the communications are displayed. In some embodiments, the communications may be displayed alongside the media content as illustrated in FIG. 8 or on a separate display as illustrated in FIG. 9.

At step 1210, the communications are analyzed to identify attributes of the media content. For example, two or more communications may be analyzed to locate repeated words or phrases. These repeated words or phrases are then assigned as attributes of the media content. In preferred forms, the words or phrases are associated with particular portions of the media content based on the receipt times of the communications containing the words or phrases.

The communications, or the keywords or passages extracted from the communications, may also be analyzed to identify relevant advertising. For example, if the communication frequently mentions a particular brand of car, clothing etc., an advertisement for the brand may be selected and then displayed.

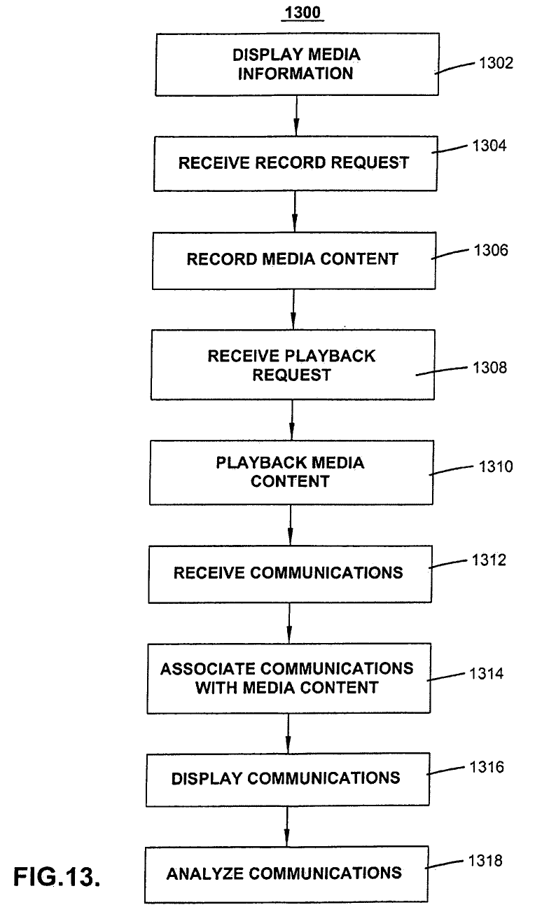

FIG. 13 shows another exemplary process 1300 for synchronizing communications with media content. Process 1300 is similar to process 1200 except that process 1300 synchronizes communications with pre-recorded media content, re-broadcast media content, and other time-shifted media content. At step 1302, media information is displayed on a display such as display 312 of user equipment device 300. The media information may be provided by a media guidance application and may include a number of media content listings arranged by time and channel in grid format.

At step 1304, a user's request to record a media content corresponding to one of the displayed media content listings is received by the media guidance application. The user may provide the recording request by placing a highlight region on the media content listing and pressing a “Record” button or other command button on an input device such as a remote control.

At step 1306, the media content selected in step 1204 is recorded to either a local storage device coupled with the user equipment 300 or to a remote storage device. The media guidance application may record a selected media content by tuning the user's equipment to the selected media content after it becomes available, sending a record command to a storage device to begin recording the content, and then stopping the recording at the conclusion of the media content. The steps performed to record media content on a remote storage device are disclosed in more detail in U.S. Patent App. Pub. No. 2005/028310 to Ellis et al., which is hereby incorporated by reference herein in its entirety.

At step 1308, a user's request to view the media content recorded in step 1206 is received. In response, the media guidance application may display a list of all recorded media content as illustrated in FIG. 6. A user may request play-back of a recorded media content by highlighting a media content listing in display 600 and then pressing “Enter” or another command on the remote control device. In response to the user request, the media guidance application issues a play-back request to either the local storage device or the remote storage device. The play-back request may include an identifier for the media content that the user wishes to play back and an identifier of the user. The play-back request may also include a pointer to a media directory on the local or remote storage device.

Process 1300 may also include steps for coordinating a group playback time for the recorded media content. The chat server or other computer may recommend several playback groups to viewers as shown in FIG. 7, or viewers may organize their own playback time and then request that a chat group be hosted in the chat server for the selected playback time.

At step 1310, the local or remote storage device retrieves the requested media content and provides it to the user equipment as a suitable signal such as an NTSC video signal or an MPEG-2 video signal. The media content may be transferred to the user equipment in real time or in a compressed form such as a compressed video file.

Steps 1304-1310 describe the playback of a recorded media content. Because the process 1200 applies equally to re-broadcast media content such as re-runs, these steps may be replaced with the steps of receiving a request to view a previously broadcast media content and tuning a receiver on the user equipment device 300 to a channel re-broadcasting the media content.

At step 1312, communications are received from viewers of the media content. As explained in more detail above, the communications may be web log entries or other chat-type messages. In some embodiments, the communications are entered by the viewers on set-top boxes coupled to the users' televisions, and in other embodiments, the communications are entered with a separate laptop computer or other device.

At step 1314, the communications are associated with particular portions of the media content based on when the communications were received. For example, the communications may be time-stamped upon receipt and then associated with particular run-time portions of the media content based on the time stamps.

At step 1316, at least some of the communications are displayed. The communications may be displayed “live” shortly after they are created or may be recorded from an earlier display of the media content and then displayed during the same run-time of a subsequent re-broadcast or playback of the media content as discussed above. In some embodiments, the communications may be displayed alongside the media content as illustrated in FIG. 8 or on a separate display as illustrated in FIG. 9.

At step 1318, the communications are analyzed to find attributes of the media content. For example, two or more communications may be analyzed to locate repeated words or phrases. These repeated words or phrases are then assigned as attributes of the media content. In preferred forms, the words or phrases are associated with particular portions of the media content based on the time stamps of the communications containing the words or phrases.

Process 1300 may also analyze the communications and/or the keywords or phrases to identify possible targeted advertising. For example, if the keywords or phrases mention a particular car, brand of sunglasses, type of clothing, etc., an advertisement related to the car, sunglasses, or clothing may be selected and displayed. The advertisement may be displayed alongside the media content as shown in FIG. 8, alongside the displayed communications, or anywhere else on the display.

Implementations of the processes and systems described above may incorporate methods to prevent misuse and abuse by providing the ability to ban users and IP addresses. For example, a user who enters communications with profanity or other objectionable content may be blocked from entering further communications. Similarly, people who read the entered communications may rate the communications based on helpfulness or some other criteria. The ratings may then be used to assign a feedback score or user rating to the people who enter the communications. Such scores or ratings can then be used to selectively filter out just the commentary of the most popular or relevant contributors.

Although the invention has been described with reference to preferred embodiments illustrated and discussed herein, equivalents may be employed and substitutions made herein without departing from the scope of the invention as recited in the claims. For example, it will be appreciated that while the discussion of media content has focused on video content such as television programs, the principles of the present invention can be applied to other types of media content, such as music, images, etc.

Having thus described the preferred embodiment of the invention, what is claimed as new and desired to be protected by Letter Patent includes the following:

1. A method for assigning attributes to media content, the method comprising the steps:
displaying a media content;
receiving from a user a communication created while viewing the media content; and
assigning at least a portion of the communication with a particular portion of the media content based on when the communication is received.

2. The method as set forth in claim 1, wherein the communication is a web log entry relating to the media content.

3. The method as set forth in claim 2, wherein the portion of the communication is a keyword contained in the web log entry.

4. The method as set forth in claim 3, wherein the assigning step includes the step of storing the keyword in a searchable database linked to the media content.

5. The method as set forth in claim 3, wherein the assigning step includes the step of embedding the keyword in a media content listing for the media content.

6. The method as set forth in claim 3, wherein the assigning step includes the step of embedding the keyword in the media content.

7. The method as set forth in claim 1, further including the steps of hosting an Internet-accessible live discussion group while the media content is displayed and receiving at the discussion group the communication and other communications from other users.

8. The method as set forth in claim 1, wherein the communication is entered with a set-top box.

9. The method as set forth in claim 1, wherein the communication is entered on a computer.

10. The method as set forth in claim 4, further comprising the steps of:
receiving a search query from a user wishing to view a media content;
comparing the search query to the searchable database; and
if the search query matches the keyword, displaying information about the media content linked to the keyword.

11. The method as set forth in claim 1, wherein the assigning step further includes the step of time-stamping the communication when it is received and associating it with the particular portion of the media content based on the time-stamp.

12. The method as set forth in claim 11, further including the steps of receiving communications from other users, time-stamping the communications, and associating the communications with particular portions of the media content based on the time-stamps.

13. The method as set forth in claim 1, further comprising the steps:
analyzing the communication and other communications received from other users to identify at least one keyword common to some of the communications; and
assigning the keyword to the media content.

14. The method as set forth in claim 1, further comprising the steps of:
analyzing the communication to identify relevant portions; and
displaying targeted advertising during the time period based on the identified relevant portions.

15. The method as set forth in claim 14, wherein the targeted advertising is displayed alongside the communication.

16. The method as set forth in claim 14, wherein the targeted advertising is displayed in an area in which the media content is displayed.

17. A method for assigning attributes to media content, the method comprising the steps:
displaying a media content;
receiving from users communications created while viewing the media content;
assigning at least a portion of the communications to particular portions of the media content based on when the communications are received;
analyzing the communications to identify at least one keyword common to some of the communications;
linking the keyword to the media content;
receiving a search query from a user wishing to view a media content;
comparing the search query to the keyword; and
if the search query matches the keyword, displaying information about the media content linked to the keyword.

18. The method as set forth in claim 17, further including the steps of hosting an Internet-accessible live discussion group while the media content is displayed and receiving at the discussion group the communications.

19. The method as set forth in claim 17, further comprising the steps of:
analyzing the communications to identify relevant portions; and
displaying targeted advertising during the time period based on the identified relevant portions.

20. A system for assigning attributes to media content, the system comprising:
control circuitry operable to display a media content on a display device;
control circuitry operable to provide a user an option to enter a communication related to the media content while viewing the media content; and
a computer for receiving the communication and assigning at least a part of the communication with a particular portion of the media content based on when the communication is received.

21. The system as set forth in claim 20, wherein the communication is a web log entry relating to the media content.

22. The system as set forth in claim 21, wherein the portion of the communication is a keyword contained in the web log entry.

23. The system as set forth in claim 22, wherein the computer stores the keyword in a searchable database linked to the media content.

24. The system as set forth in claim 22, wherein the computer embeds the keyword in a media content listing for the media content.

25. The system as set forth in claim 22, wherein the computer embeds the keyword in the media content.

26. The system as set forth in claim 20, wherein the computer is a web server that hosts a live discussion group while the media content is displayed and receives the communication and other communications from other users while the media content is viewed.

27. The system as set forth in claim 20, wherein the computer time-stamps the communication.

28. The system as set forth in claim 27, wherein the computer associates the communication with the particular portion of the media content based on the time-stamp.

29. The system as set forth in claim 20, wherein the control circuitry operable to display and the control circuitry operable to provide are a part of a single device.

30. The system as set forth in claim 20, wherein the control circuitry operable to display and the control circuitry operable to provide are incorporated in separate devices.

31. A system for assigning attributes to media content, the system comprising:
means for displaying a media content;
means for receiving from a user a communication created while viewing the media content; and
means for assigning at least a portion of the communication with a particular portion of the media content based on when the communication is received.

32. The system as set forth in claim 31, wherein the communication is a web log entry relating to the media content.

33. The system as set forth in claim 32, wherein the portion of the communication is a keyword contained in the web log entry.

34. The system as set forth in claim 33, further including means for storing the keyword in a searchable database linked to the media content.

35. The system as set forth in claim 33, further including means for embedding the keyword in a media content listing for the media content.

36. The system as set forth in claim 33, further including means for embedding the keyword in the media content.

37. The system as set forth in claim 31, further including means for hosting an Internet-accessible live discussion group while the media content is displayed and for receiving at the discussion group the communication and other communications from other users.

38. The system as set forth in claim 31, wherein the communication is entered with a set-top box.

39. The system as set forth in claim 31, wherein the communication is entered on a computer.

40. The system as set forth in claim 34, further comprising:
means for receiving a search query from a user wishing to view a media content;
means for comparing the search query to the searchable database; and
means for displaying information about the media content linked to the keyword if the search query matches the keyword.

41. The system as set forth in claim 31, further including means for time-stamping the communication when it is received and associating it with the particular portion of the media content based on the time-stamp.

42. The system as set forth in claim 41, further including means for receiving communications from other users, time-stamping the communications, and associating the communications with particular portions of the media content based on the time-stamps.

43. The system as set forth in claim 31, further comprising:
means for analyzing the communication and other communications received from other users to identify at least one keyword common to some of the communications; and
means for assigning the keyword to the media content.

44. The system as set forth in claim 31, further comprising:
means for analyzing the communication to identify relevant portions; and
means for displaying targeted advertising during the time period based on the identified relevant portions.

45. The system as set forth in claim 44, wherein the targeted advertising is displayed alongside the communication.

46. The system as set forth in claim 44, wherein the targeted advertising is displayed in an area in which the media content is displayed.

47. A system for assigning attributes to media content, the system comprising:
means for displaying a media content;
means for receiving from users communications created while viewing the media content;
means for assigning at least a portion of the communications to particular portions of the media content based on when the communications are received;
means for analyzing the communications to identify at least one keyword common to some of the communications;
means for linking the keyword to the media content;
means for receiving a search query from a user wishing to view a media content;
means for comparing the search query to the keyword; and
means for displaying information about the media content linked to the keyword if the search query matches the keyword.

48. The system as set forth in claim 47, further including means for hosting an Internet-accessible live discussion group while the media content is displayed and for receiving at the discussion group the communications.

49. The system as set forth in claim 47, further comprising:
means for analyzing the communications to identify relevant portions; and
means for displaying targeted advertising during the time period based on the identified relevant portions.
